(19) United States
(12) Patent Application Publication
(10) Pub. No.: US 2026/0031678 A1
(43) Pub. Date: Jan. 29, 2026

(54) HIGH VIBRATION MOTOR

(71) Applicant: MOLON MOTOR & COIL CORPORATION, Arlington Heights, IL (US)

(72) Inventor: Emilio A. RAMIREZ, Roselle, IL (US)

(73) Assignee: MOLON MOTOR & COIL CORPORATION, Arlington Heights, IL (US)

(21) Appl. No.: 19/278,409

(22) Filed: Jul. 23, 2025

Related U.S. Application Data
(60) Provisional application No. 63/674,705, filed on Jul. 23, 2024.

(51) Int. Cl. H02K 5/24; H02K 7/116; H02K 11/33

(52) U.S. Cl. CPC H02K 5/24; H02K 7/1166; H02K 11/33; H02K 2211/03

(57) ABSTRACT

A compact miniature motor system includes a motor configured to rotate an output shaft on an axis. The compact miniature motor system also includes a series of gears to drive the motor and a housing. The housing includes: a set of ribs that correspond to the shape of the motor; a first axial retaining wall at a first end of the motor when the housing is installed with the motor; and a second axial retaining wall at a second end of the motor when the housing is installed with the motor, where the second end of the motor opposes the first end of the motor. The notch is configured to mate with a corresponding groove of the motor. The first and second axial retaining walls prevents movement of the motor axially, the set of ribs are configured to prevent radial movement of the motor, and the notch is configured to prevent rotational movement of the motor, so that vibrations of the motor are prevented allowing the motor to not produce high vibrations

### BACKGROUND

Existing designs for canned drink vending machine motors that operate at or above 100 inch-pounds are characterized by heavy duty shaded pole motors, zinc gear boxes, all metal gears with sleeve or needle bearings, and oversized installation envelopes.

In addition, the cost and weight for such designs are among the highest for subfractional horsepower gear motors. For example, present designs for vending machines include add-on brackets for custom mounting. Moreover, it is generally known that shaded pole motors are among the most inefficient types of motors in general use. Exemplary prior art devices are discussed below.

U.S. Pat. No. 5,446,326 issued to Scheider on Aug. 29, 1995, for a vending machine gear motor including a plastic gear box. As shown in FIG. 1 of his U.S. patent, the gear motor of Scheider comprises a gear box 11 having a generally hollow plastic gear box housing 12, a gear train 14 mounted therein, and an electronically insulating cover 13.

U.S. Pat. No. 5,256,921 issued to Pruis et al. on Oct. 26, 1993, for a gear motor with a rotary switch. The gear motor has an output shaft for driving a dispensing mechanism of a vending machine. As shown in FIGS. 2 and 3 of their U.S. patent, the gear motor of Pruis et al. includes an electric motor 12 mounted on a printed circuit board 13 and also includes an output shaft 14 which drives a conventional gear reduction unit 16.

U.S. Pat. No. 5,404,060 issued to Nakahashi et al. on Apr. 4, 1995, for a miniature motor with a worm reduction gear. The miniature motor includes a motor section 1 which transmits torque generated from a motor shaft 3 to a worm 4, then to a helical gear 5 in a reduction gear section 2, and eventually to an output shaft 6.

U.S. Pat. No. 5,172,605 issued to Schwartz on Dec. 22, 1992, and is assigned to the same assignee as the present invention. Schwartz discloses an electric motor gearbox for a vending machine. The gearbox has four main parts: a housing, a minimotor, a printed circuit board, and an assembly of plastic gears.

Various other gearing mechanisms relating to relatively small motors of general interest are disclosed in U.S. Pat. No. 5,747,903 issued to Klingler on May 5, 1998 and in U.S. Pat. No. 5,734,210 issued to Keutz on Mar. 31, 1998.

Despite these recent developments, it remains a problem in the prior art to develop a compact miniature motor with high torque for a gearcase which makes efficient use of space in a vending machine.

### SUMMARY

Embodiments of the present invention features unique improvements in the use of engineering plastics. The layout of components is compact, taking advantage of a right angle drive which, in this particular case, is a first-stage worm gear.

In one embodiment, a compact miniature motor system includes a motor configured to rotate an output shaft on an axis. The compact miniature motor system also includes a series of gears to drive the motor and a housing. The housing includes: a set of ribs that correspond to the shape of the motor; a first axial retaining wall at a first end of the motor when the housing is installed with the motor; and a second axial retaining wall at a second end of the motor when the housing is installed with the motor, where the second end of the motor opposes the first end of the motor. The notch is configured to mate with a corresponding groove of the motor. The first and second axial retaining walls prevents movement of the motor axially, the set of ribs are configured to prevent radial movement of the motor, and the notch is configured to prevent rotational movement of the motor, so that vibrations of the motor are prevented allowing the motor to not produce high vibrations

This arrangement keeps a motor compact inside a gearbox which makes efficient use of space in a vending machine, and any other unit requiring an application of high torque in a small space.

A gear train within a main casing has standard available gears. However, the transfer stage from the worm gear down to a plurality of cluster gears within the gearbox is flexibly arranged for a variety of gear ratios. This flexibility is introduced by adjusting the ratio between the first-stage worm gear with single, double or quadruple threads and a double pinion transfer gear.

A metallic output shaft is supported directly within the gearbox without introducing additional bearings. The lifetime of the gearbox for directly supporting the output shaft is very predictable. Thus, this novel arrangement reduces costs over the lifetime of the gearbox quite noticeably.

A number of features support quiet operation in addition to the first-stage worm gear. The gearbox has close envelope contours to retain grease in the gear train. This close envelope also aids quiet operation. A plurality of acoustical chambers surround the gear train and insulate against noise transfer. In addition, the motor is covered with an enclosure that further insulates against noise transmission, dust, moisture, etc.

Unique to the present invention is the double pinion transfer gear that is supported by inverted trunnions. Instead of extroverted trunnions supports used in the prior art, the transfer gear of the present invention has internal space provided at its ends for supports that extend inside the transfer gear, thus shortening the unsupported length of the transfer gear, when compared to the prior art which uses transfer gears that are virtually unsupported except at the very tips of their ends. Consequently, the invention provides a more stable gear mesh operation. Also, a motor cover provides outside support for the transfer gear at one end of the worm gear.

The rating of the gear motor can have a direct current (DC) voltage of either 12, 24, 36 or 48 volts. Furthermore, a printed circuit (PC) board is mounted on the gear motor to rectify from either 120 or 240 alternating circuit (AC) voltage to DC voltage. The PC board includes components for rectifying, filtering for constant DC, and limiting overloads with a positive temperature coefficient (PTC) resistor. A reversing switch is also used reverse direction of rotation. The PC board is connected to AC voltage by a header mounted thereon.

Materials for both the gearbox and the cover are acrylonitrile butadinene styrene (ABS) copolymers or other engineering plastics with or without reinforcement in the matrix. Gears are made of delrin, nylon or other engineering plastics. Upper stage gears are formed from powdered metal or fine metallic blanks. Thus, the output shaft, its cross pin and other elements for transmitting torque are fabricated out of either powdered metal or metallic blanks. Also, a socket and other features may be used for coupling the output shaft.

Grease is selected from the high-performance synthetic greases with a tolerance for both high and low temperatures. The poly-alpha-olefins have been found satisfactory in this regard.

A key advantage of the present invention is that no anti-back-drive brake is necessary because of the use of the first-stage worm gear which typically cannot be back driven.

Thus, it is one object to provide miniature motors that are compact, higher torque and can adopt to high vibration environments as well as both high and low temperature, have noise control features, have higher efficiencies when compared to shaded pole types, and/or are inexpensive to construct.

Another object is to provide a compact machine motor with a rectifier circuit on its PC board in cases of high DC voltage application at 120V to 240V.

### BRIEF DESCRIPTION OF THE DRAWINGS

A more complete appreciation of the invention and many of its attendant advantages will be readily obtained as the invention becomes better understood by reference to the following detailed description when considered in connection with the accompanying drawings.

FIG. 1 is a cutaway top plan view of a compact miniature motor of the present invention inside gearbox.

FIG. 2 is a side elevational view of the compact miniature motor inside the gearbox.

FIG. 3 is a cross-sectional view taken along line 3-3 of FIG. 1.

FIG. 4 is a schematic view of a PC board wired to the compact miniature motor.

FIGS. 5-19 illustrate a compact miniature motor according to additional embodiments.

### DETAILED DESCRIPTION OF THE INVENTION

Referring now to the drawings, like reference numerals designate identical or corresponding parts throughout the several views. Features of the invention will become apparent in the course of the following description of a preferred embodiment which is given only for illustration of the invention and which is not intended to be limiting thereof.

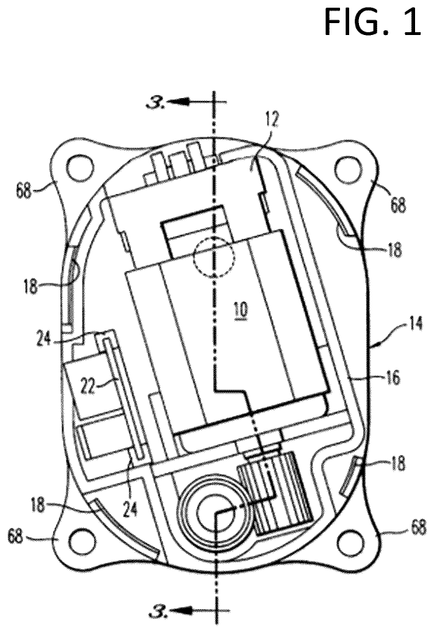

In FIG. 1, a DC motor 10 has a permanent magnet 12 attached thereto inside a gearbox 14. The permanent magnet 12 produces an electromagnetic field necessary for operating the DC motor 10. A first cover 16 protects the motor 10 inside the gearbox 14. A plurality of curved corner tabs 18 interlock the gearbox 14 to a second cover (not shown in FIG. 1). A PC board 22 is retained inside the gearbox 14 by molded plastic guides 24. The gearbox 14 has a plurality of extended corner feet 68 which allow the entire unit to be custom mounted to the device being operated.

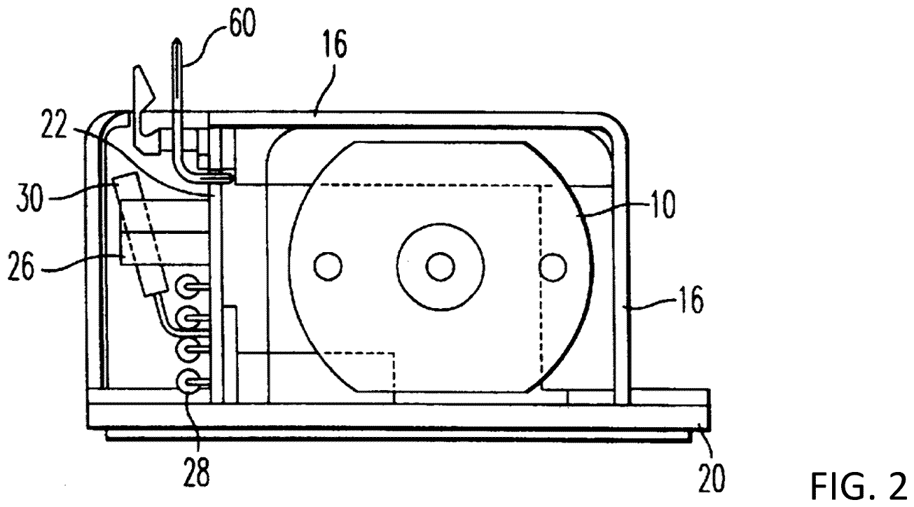

In FIG. 2, the second cover 20 is shown underneath the motor 10 which is also protected overhead by the first cover 16. The second cover 20 is interlocked to the gearbox 14 of FIG. 1 by the tabs 18, not shown in FIG. 2 but seen in FIG. 1. The PC board 22 has attached thereto an electrolytic capacitor 26 for filtering constant DC, a plurality of diodes 28 forming a full-wave bridge, and a motor fuse 30 which is preferably a PTC resistor.

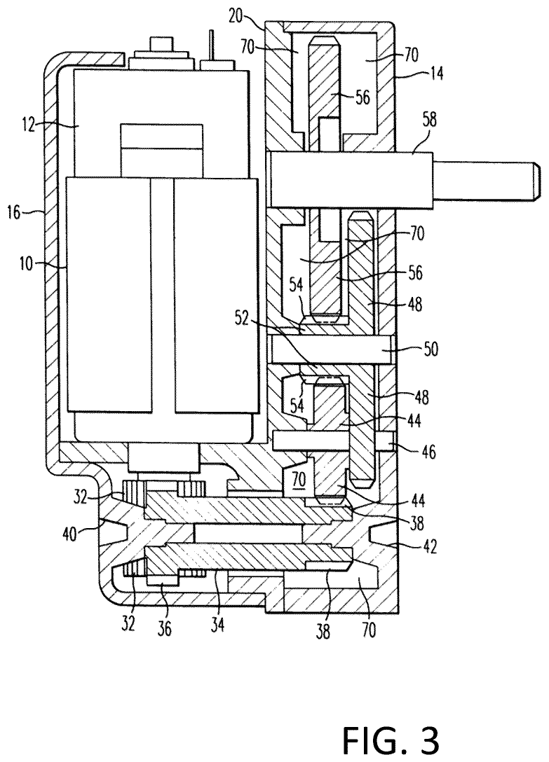

In FIG. 3, the first cover 16 is shown protecting the motor 10 and the permanent magnet 12 which may be inside the motor 10. The second cover 20 is also shown protecting the gearbox 14. A first-stage worm gear 32 is driven directly by the motor 10 at one end. The worm gear 32 drives at a right angle a molded double pinion transfer gear 34. At one end of the transfer gear 34, a first set of teeth 36 mesh with the worm gear 32. At another opposite end of the transfer gear 34, a second set of teeth 38 are formed in a side thereof and change rotation from a right angle to a plurality of gears which are aligned parallel to the first-stage worm gear 32. A pair of internal trunnions 40 and 42 make the transfer gear 34 stable by extending therein and engaging longitudinally the inside thereof from opposite ends. The one trunnion 40 is molded at one end to the first cover 16 while the other trunnion 42 is molded at its opposite end to the gearbox 14. The teeth 38 on the transfer gear 34 mesh with a first cluster gear 44 which has a first gear pin 46 for stabilizing the first cluster gear 44 between the gear box 14 and the second cover 20. In turn, the first cluster gear 44 drives a second cluster gear 48 which has a second gear pin 50 for likewise stabilizing the second cluster gear 48 between the gearbox 14 and the second cover 20. The second cluster gear 48 has a short shaft portion 52 with teeth 54 which engage on one side with the first cluster gear 44 and which engage on an opposite side with an output gear 56. This output gear 56 is fixed around and drives an output shaft 58 at a right angle. Thus, a gear train extending from the worm gear 32 to the transfer gear 34 to the first cluster gear 44 to the second cluster gear 48 to the output gear 56 is compact because it wraps tightly around the motor 10 in the shape of the capital letter J.

Noise generated by the gear train is suppressed by grease packed in a plurality of acoustical chambers 70 which are formed between the gearbox 14 and the second cover 20. The output shaft 58 drives a product mover for canned beverages inside a vending machine or any other electromechanical unit requiring the application of high torque.

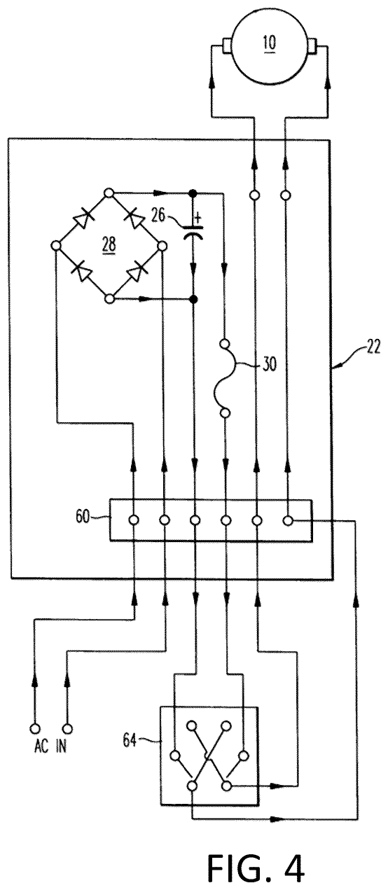

In FIG. 4, AC voltage enters the PC board 22 at one end and is received by a header 60 mounted on the PC board 22 before exiting to energize the motor 10. After leaving the header 60, the AC voltage passes through the plurality of diodes 28, which in this case number four and which form a full-wave bridge to rectify the AC voltage. After leaving the plurality of diodes 28, the voltage is processed by the electrolytic capacitor 26 which is mounted to the PC board 22 and which filters for constant DC. The voltage then goes through the PTC resistor 30 which is also mounted to the PC board 22 and which functions as the motor fuse 30 to prevent overloads. The voltage passes again through the header 60 before reaching a switch 64 for reversing the current back through the header 60 and out to the motor 10. The reversing switch 64 is mounted outside the PC board 22 to the first cover 16, not shown in FIG. 4 but seen in FIG. 2.

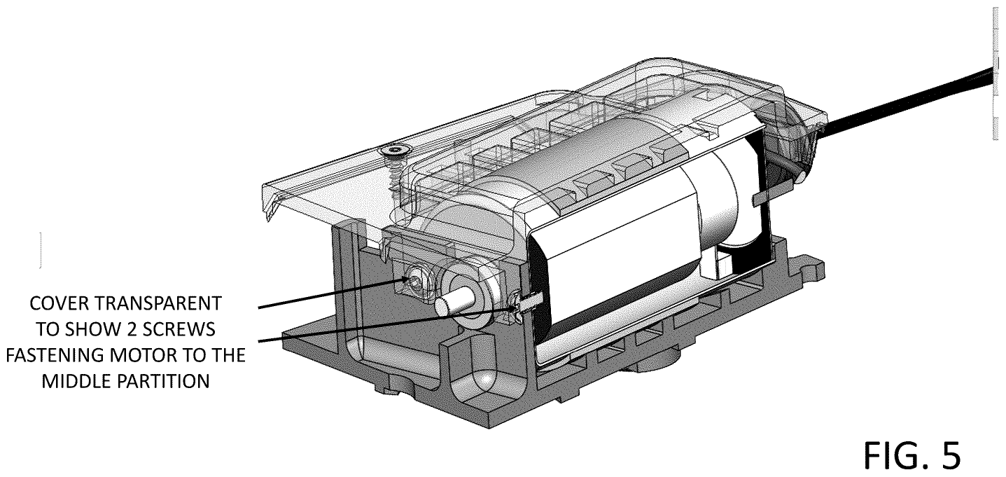

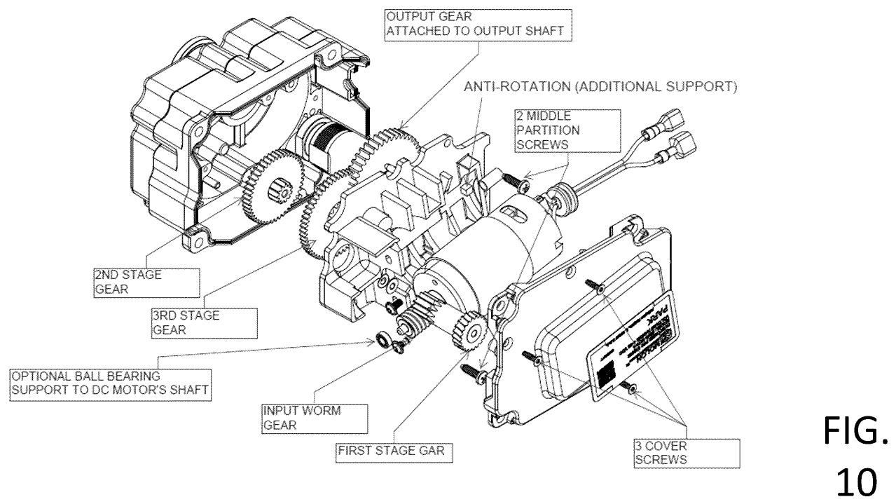

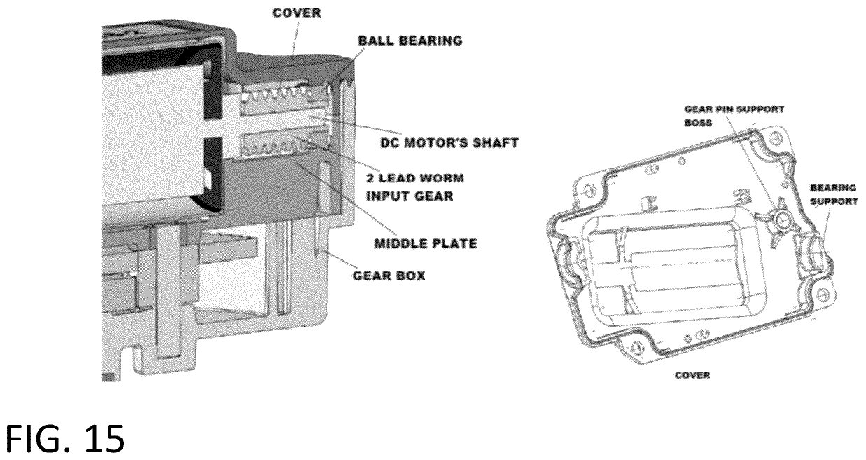

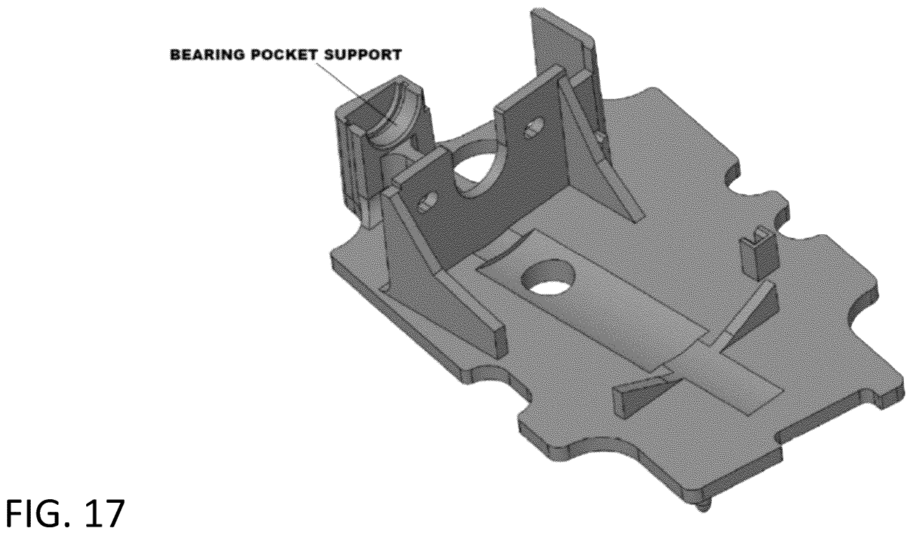

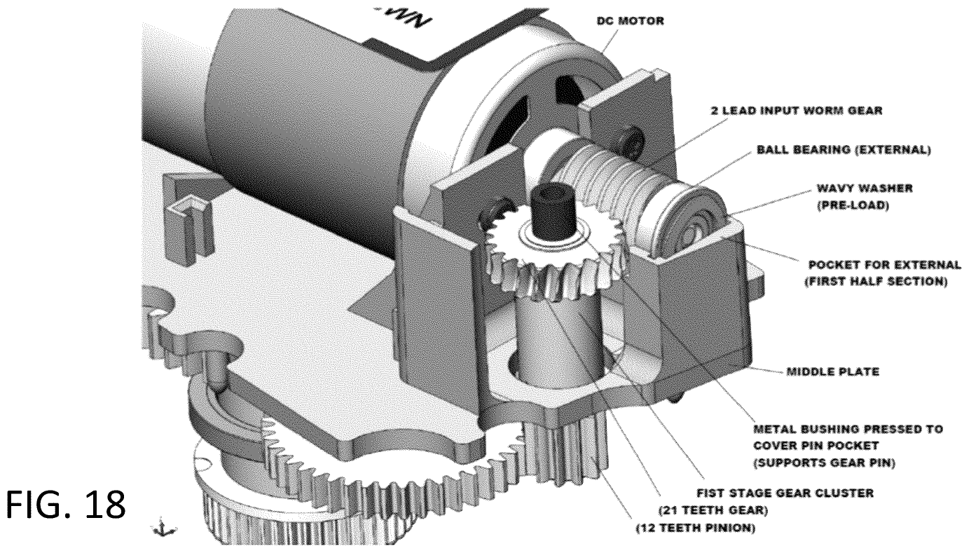

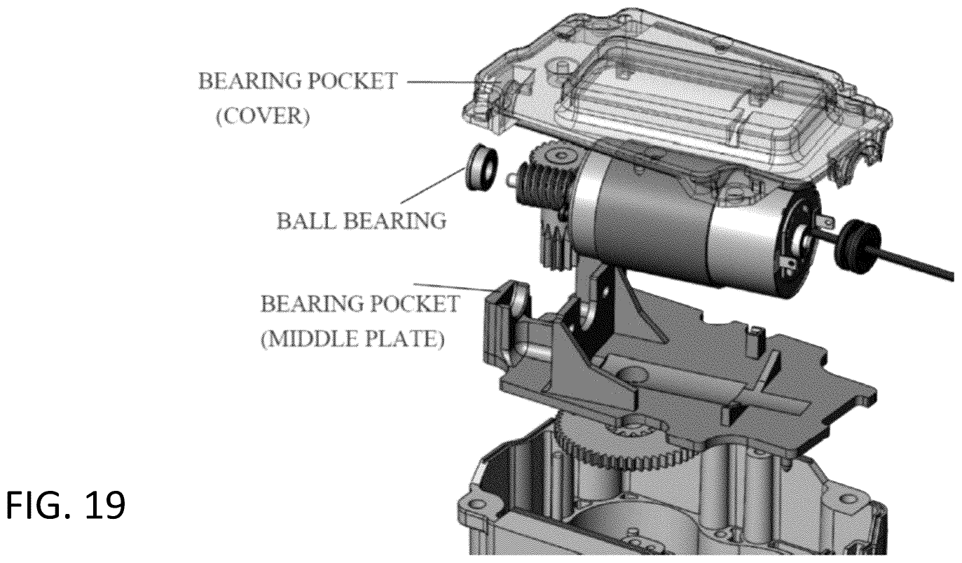

FIGS. 5-19 illustrate a compact miniature motor according to additional embodiments. This motor can be in any different shape gearbox that would fit mounting and envelope requirement, but with specific special features:
1. a motor gearbox that has a front and back wall that restrains the DC motor from moving axially;
2. a DC motor that has two relief pockets (or similar feature) that are 180 degrees apart;
3. a motor gearbox that has two corresponding ribs (on in the box and one in the cover) to mate with DC motor's relief pockets;
4. once the gearbox is assembled together the ribs on both gearbox and cover interact with the motor's relief pockets to lock the DC motor in place and prevent the DC motor from rotating;
5. the DC motor is then captured by both the box and the cover through its front and backwall pocket features, thereby preventing the DC motor from moving axially and through its two “relief ribs” interacting with the DC motor's relief pockets (or similar feature) which prevents the entire DC motor from rotating or moving radially when torque is applied to the output shaft; and
6. the DC motor has a simplified mounting scheme without the use of screws. In some embodiments, there are two screws (see FIGS. 5 & 6) as additional support to secure the DC motor to the frame due to high vibration requirements (e.g., ISO 16750 Sinusoidal Vehicular Vibration requirements).

This motor gearbox assembly is used in two (2) applications: a non-park motor which is rated at 32 in-lbs of torque, and a park motor which is rated at 300 in-lbs of torque.

The gears in on the non-park motor being a low torque application is made with plastic materials and powdered metal. The gears in the park motor being a high torque motor application is made up of all steel/metal materials.

Using the same gear centers as discussed above, but with two different gear ratio, 363.66:1 for the non-park (low torque) and 663:1 gear ratio for the park (high torque motor).

Both motors above will have the same gearbox and the same output shaft.

FIG. 5 illustrates how there are two screws that fasten to the motor through the housing to prevent rotation of the motor relative to the housing.

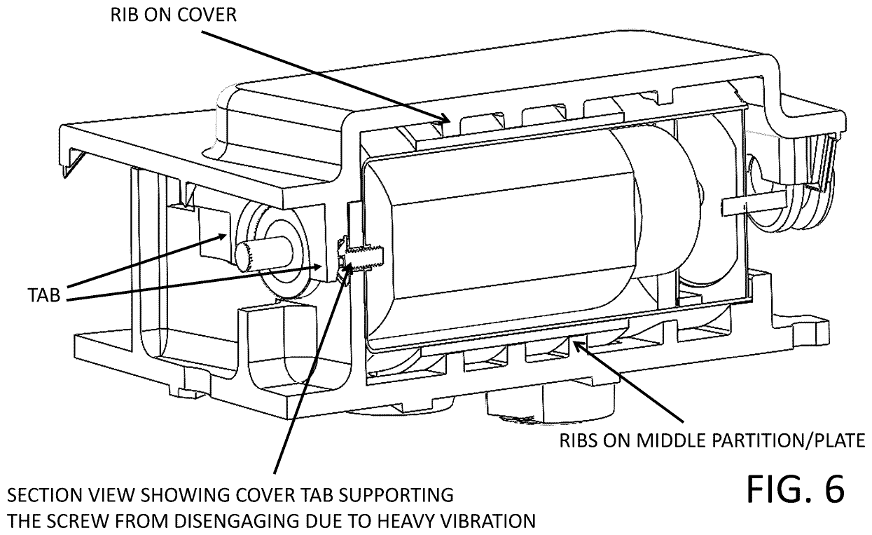

FIG. 6 illustrates how there are ribs on the cover and partition plate to cradle and keep the motor snug in the housing. The ribs are configured to conform to the shape of the motor so that the ribs make continuous contact with the motor on the top and bottom portions of the motor as shown in the figures.

Also shown in FIG. 6 are tabs that extend over where the screws in FIG. 5 screw through the housing. The tabs are configured to ensure that the screws do not rotate out due to vibrations.

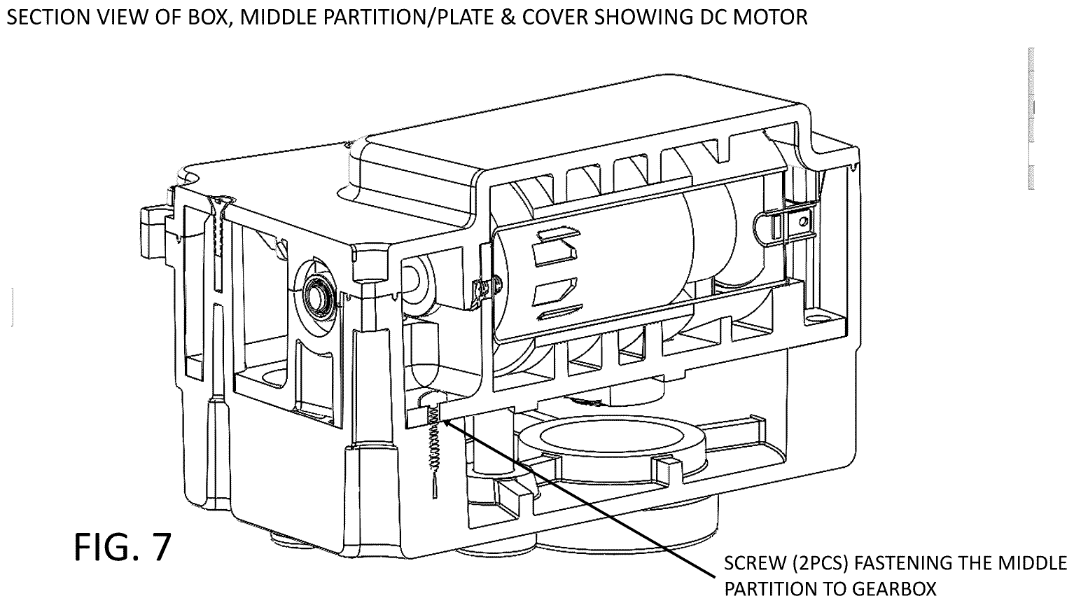

FIG. 7 illustrates that there are screws which secure the middle partition plate to the gearbox so that the partition plate is securely fastened to the gearbox and becomes one solid piece of the entire assembly not allowing it float during vibration,

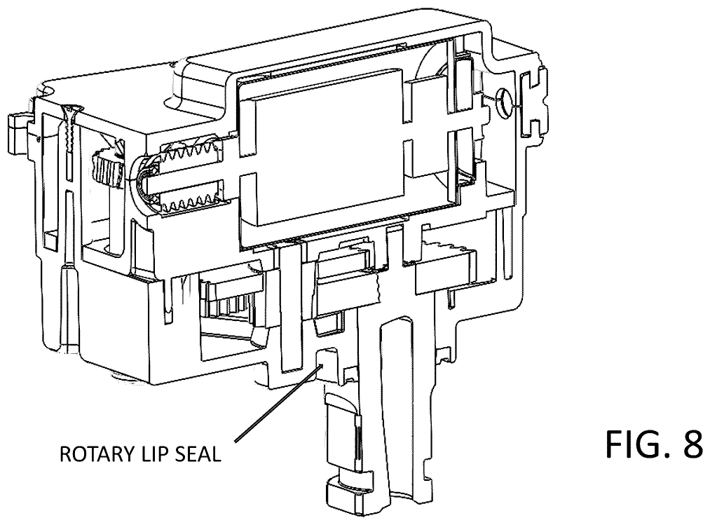

FIG. 8 illustrates a rotary seal is provided around the output shaft to seal the output shaft. The rotary seal is configured to extend completely around the output shaft.

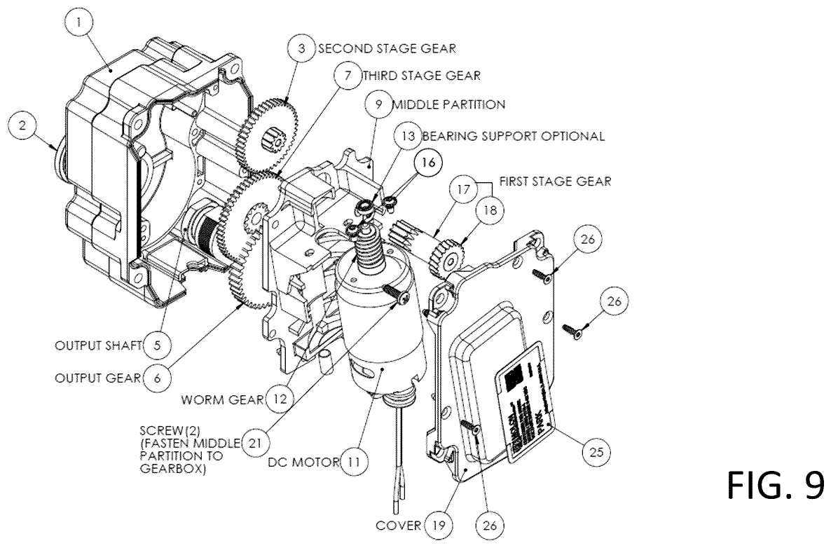

FIGS. 9-10 and FIG. 13 both illustrate an exploded view of the motor. The middle partition is shown as well as the arrangement of the gears and the other features discussed herein. Additionally, an antirotation protrusion is provided on the middle partition plate. The antirotation protrusion mates with a hole on the motor so that such mating transfers any forces from the motor to the middle partition plate. Thus, since the middle partition plate is fixed to the gearbox and any rotational forces applied to the motor are transferred to the middle partition plate, the motor does not rotate relative to the middle partition plate or the gearbox. As such, the motor is fixed and will not vibrate.

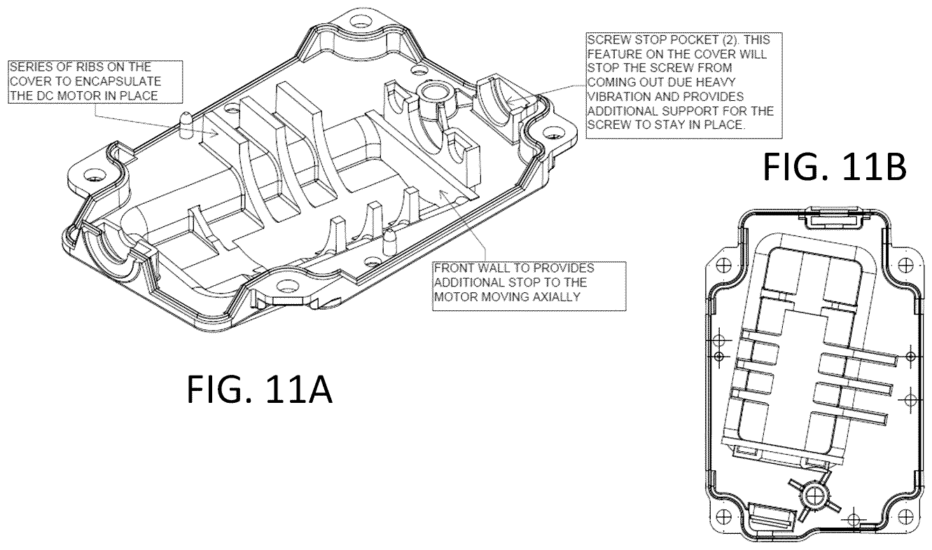

FIGS. 11A and 11B illustrate the middle partition plate in additional embodiments. As shown, the ribs on the middle partition plate cover encapsulate the motor to keep it in place. Additionally, a front wall provides additional stop to the motor moving axially to keep the motor from moving in an axial direction while the anti-rotation protrusion prevents rotational and angular movement, and while the ribs prevents movement of the motor radial movement of the motor, thus restricting all movements of the motor

Additionally, there is a screw stop pocket at the end of the middle partition plate cover which will stop the screw from coming out due to vibrations of the motor and provides additional support for the screw to stay place.

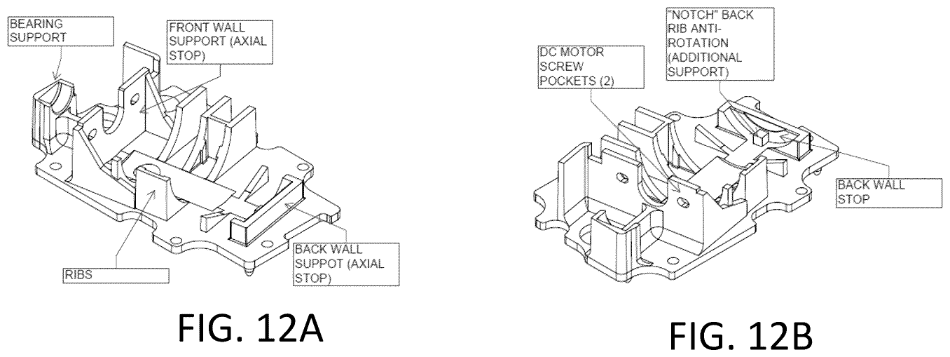

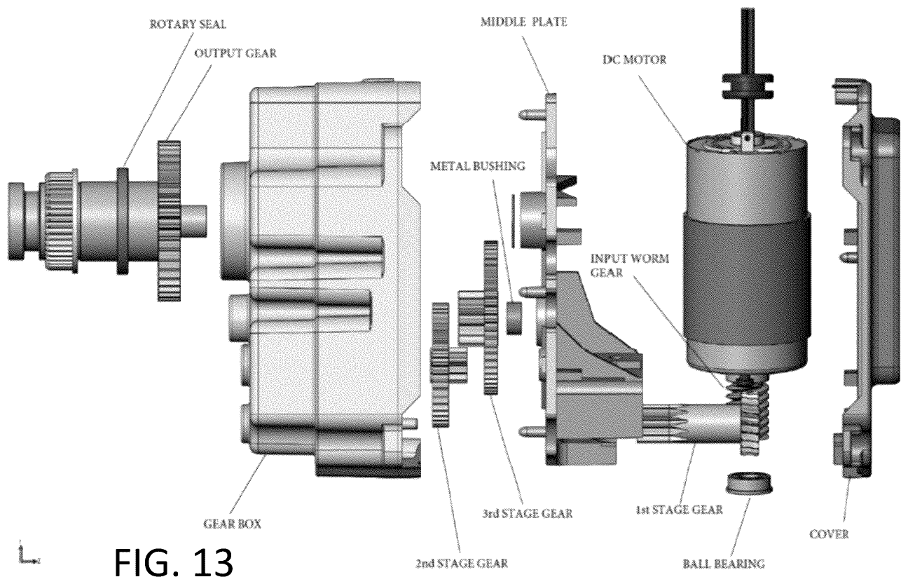

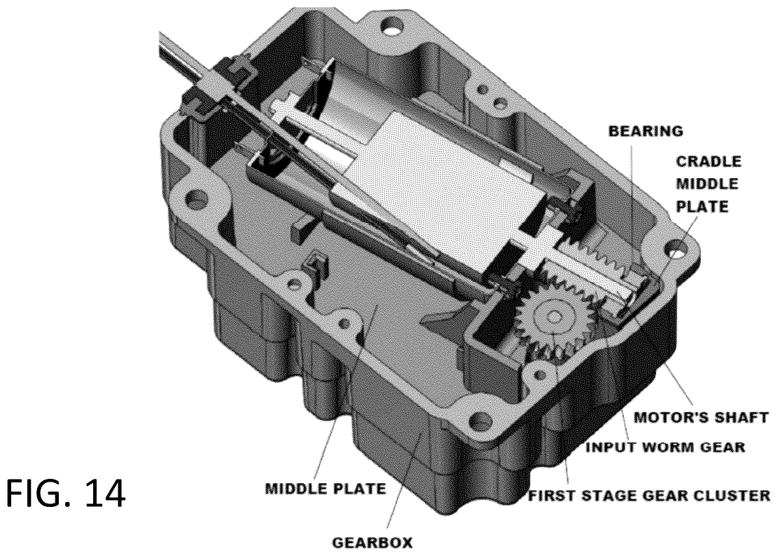

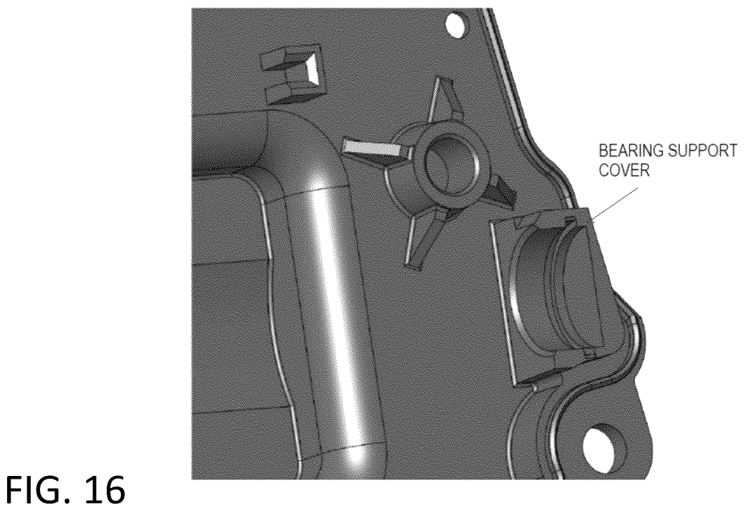

FIGS. 12A and 12B show a front wall support which includes screw holes/pockets to screw the motor in relative to the middle partition plate. There is also a bearing support pocket shown (which is also shown in FIG. 16 and FIG. 14). As shown in FIG. 14, the cradle middle plate is the bearing support pocket which is park of the middle partition plate (see FIGS. 13, 19 and 17). The bearing support pocket receives a bearing and is configured to hold the bearing in place.

Referring back to FIGS. 12A and 12B, the back wall support is also shown, which is an axial stop as discussed above.

It should be noted that the motor of FIGS. 5-19 do not include a printed circuit board (PCB), has high vibration features (e,g,m antirotation notch, ribs, etc.), includes a rotary seal, and uses a worm gear instead of a bevel.

Numerous modifications and variations of the present invention are possible in light of the above teachings. Thus, it is to be understood that, within the scope of the appended claims, the invention may be practiced otherwise than as specifically described herein.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

What is claimed is:

1. A compact miniature motor system comprising:
a motor configured to rotate an output shaft on an axis, the motor being aligned on the axis;
a series of gears to drive the motor;
a housing comprising:
a top cover comprising a first set of ribs that correspond to the shape of a top portion of the motor;
a bottom cover comprising a second set of ribs that correspond to the shape of a bottom portion of the motor;
a first axial retaining wall configured to be proximate to a first end of the motor when the housing is installed with the motor;
a second axial retaining wall configured to be proximate to a second end of the motor when the housing is installed with the motor, where the second end of the motor opposes the first end of the motor;
a notch configured to mate with a corresponding groove of the motor,
wherein (1) the first and second axial retaining walls prevents movement of the motor axially, (2) the first and second set of ribs are configured to prevent radial movement of the motor and (3) the notch prevents rotational movement of the motor, so that vibrations of the motor are prevented allowing the motor to not produce high vibrations.

2. The compact miniature motor, according to claim 1, further comprising:
a worm gear driven at one end by the motor;
a pinion transfer gear engaging at one end at a right angle with the worm gear;
at least one cluster gear engaging at a right angle with another end of the pinion transfer gear;
an output gear driven by the at least one cluster gear; and
an output shaft engaging at a right angle with the output gear;
whereby the worm gear, the pinion transfer gear, the at least one cluster gear and the output gear form a gear train that wraps tightly around the motor in the shape of a capital letter J.

3. The compact miniature motor, according to claim 1, further comprising:
a first cover for protecting the DC motor;
a gearbox for containing the gear train; and
solid steel pin, connected at one end to the first cover and connected at an opposite end to the gearbox, for stabilizing the pinion transfer gear.

4. The compact miniature motor, according to claim 3, wherein:
said solid steel pin extend longitudinally inside opposite ends of the pinion transfer gear.

5. The compact miniature motor, according to claim 3, further comprising:
a second cover for protecting the gear train; and
at least one acoustical chamber, packed with grease and formed between the gearbox and the second cover, for suppressing noise generated by the gear train.

6. The compact miniature motor, according to claim 3, further comprising:
a PC board attached to the first cover.

7. The compact miniature motor, according to claim 6, further comprising:
a header, mounted on the PC board, for receiving AC voltage;
a plurality of diodes electrically connected to the header and formed into a full wave bridge for rectifying the AC voltage;
an electrolytic capacitor, mounted on the PC board, for filtering for constant DC;
a PTC resistor, mounted on the PC board, for preventing overloads; and
a switch, mounted on the first cover, for reversing current back through the header and out to the DC motor;
whereby the AC voltage is rectified, filtered for constant DC, and modified to prevent overloads before exiting the PC board to energize the DC motor.

8. The compact miniature motor, according to claim 1, wherein the top cover further comprises motor screw pockets to align with a top portion of a screw and configured to prevent the screw from moving in a direction that is associated with counterclockwise movement of the screw.

9. The compact miniature motor, according to claim 1, further comprising two screws configured to screw the housing to the motor.

10. The compact miniature motor, according to claim 1, further comprising a rotary seal is provided around the output shaft to seal the output shaft.

11. A compact miniature motor system comprising:
a series of gears to be driven on an axis by an output shaft of a motor;
a housing comprising:
a set of ribs that correspond to the shape of the motor;
a first axial retaining wall at a first end of the motor when the housing is installed with the motor;
a second axial retaining wall at a second end of the motor when the housing is installed with the motor, where the second end of the motor opposes the first end of the motor;
a notch configured to mate with a corresponding groove of the motor,
wherein the first and second axial retaining walls prevents movement of the motor axially and wherein the set of ribs are configured to prevent radial movement of the motor and wherein the notch prevents rotational movement of the motor, so that vibrations of the motor are prevented allowing the motor to not produce high vibrations.

12. The compact miniature motor, according to claim 1, wherein the top cover further comprises motor screw pockets to align with a top portion of a screw and configured to prevent the screw from moving in a direction that is associated with counterclockwise movement of the screw.

13. The compact miniature motor, according to claim 1, further comprising two screws configured to screw the housing to the motor.

14. The compact miniature motor, according to claim 1, further comprising a rotary seal is provided around the output shaft to seal the output shaft.
